(19) United States
(12) Patent Application Publication
(10) Pub. No.: US 2018/0291860 A1
(43) Pub. Date: Oct. 11, 2018

(54) CRIMPED WIRING IN AN AUTOMOTIVE POWER CONFIGURATION

(71) Applicants: Parithi Gopal, Canton, MI (US); Darrin Nollen, Ypsilanti, MI (US); Yasuhiro Ono, Novi, MI (US)

(72) Inventors: Parithi Gopal, Canton, MI (US); Darrin Nollen, Ypsilanti, MI (US); Yasuhiro Ono, Novi, MI (US)

(21) Appl. No.: 15/479,523

(22) Filed: Apr. 5, 2017

(51) Int. Cl. F02N 19/00; B60R 16/033; F02N 11/10

(52) U.S. Cl. CPC F02N 19/001; F02N 11/10; B60R 16/033

(57) ABSTRACT

An automotive power configuration may include a battery, a starter, an ACG fuse, and a electronic control module (ECM). The starter and the ACG fuse are electrically connected by a first wire, and the starter and the ECM are electrically connected to the battery by a second wire and a third wire, respectively. The second and third wire may be crimped together to form a combined cable that connects to a terminal of the battery.

### BACKGROUND

The embodiments described herein pertain to variations of wiring for an automotive power configuration.

Typically, at the time of vehicular start-up, the vehicle's battery provides power to the engine control module (ECM) and starter. After start-up, the vehicle's ACG fuse provides power to the starter.

### SUMMARY

In one example embodiment, an automotive power configuration includes a battery, a starter, an ACG fuse, and a electronic control module (ECM). The starter and the ACG fuse are electrically connected by a first wire, and the starter and the ECM are electrically connected to the battery by a second wire and a third wire, respectively. The second and third wire are crimped together to form a combined cable that connects to a terminal of the battery.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows a known automotive power configuration;

FIG. 2 shows an example implementation of an automotive power configuration in accordance with at least some of the examples described herein; and

FIG. 3 shows an example implementation of crimped wiring for an automotive power configuration in accordance with at least some of the examples described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

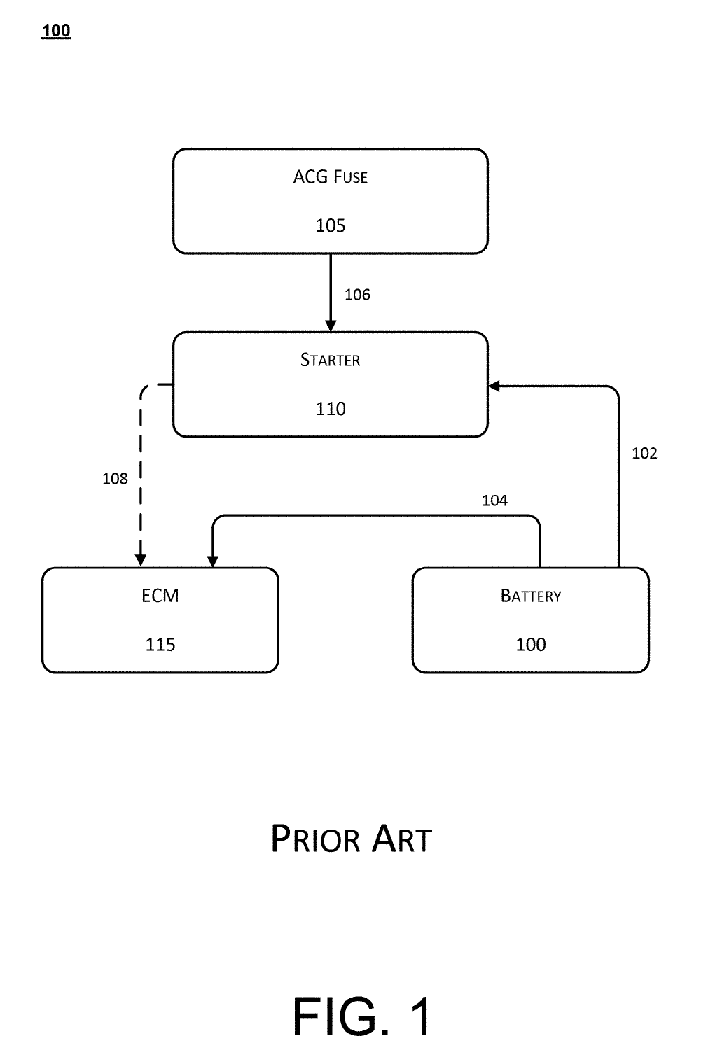

FIG. 1 shows a known automotive power configuration.

As depicted, the known power configuration includes battery 100, ACG fuse 105, starter 110, and engine control module (ECM) 115.

Battery 100 may refer to a rechargeable battery that supplies electric energy for automotive components, particularly for starting, lighting, and ignition.

When starting an automobile, battery 100 provides or directs power to starter 110, via wire 102, and to ECM 115, via wire 104.

AGC fuse 105 may refer to a glass fuse, typically used in automotive applications. After the vehicle has started, ACG fuse 105 provides or directs power to starter 110.

Starter 110 may refer to an engine. Starter 110 may be an electric, pneumatic, hydraulic, or internal-combustion engine. Starter 110 may provide or direct power to ECM 115, via wire 108, if wire 104 becomes unplugged or otherwise unserviceable.

ECM 115 is an internal (to the vehicle) computer that manages, e.g., the ignition, fuel injection, emission systems, transmission and anti-lock braking systems.

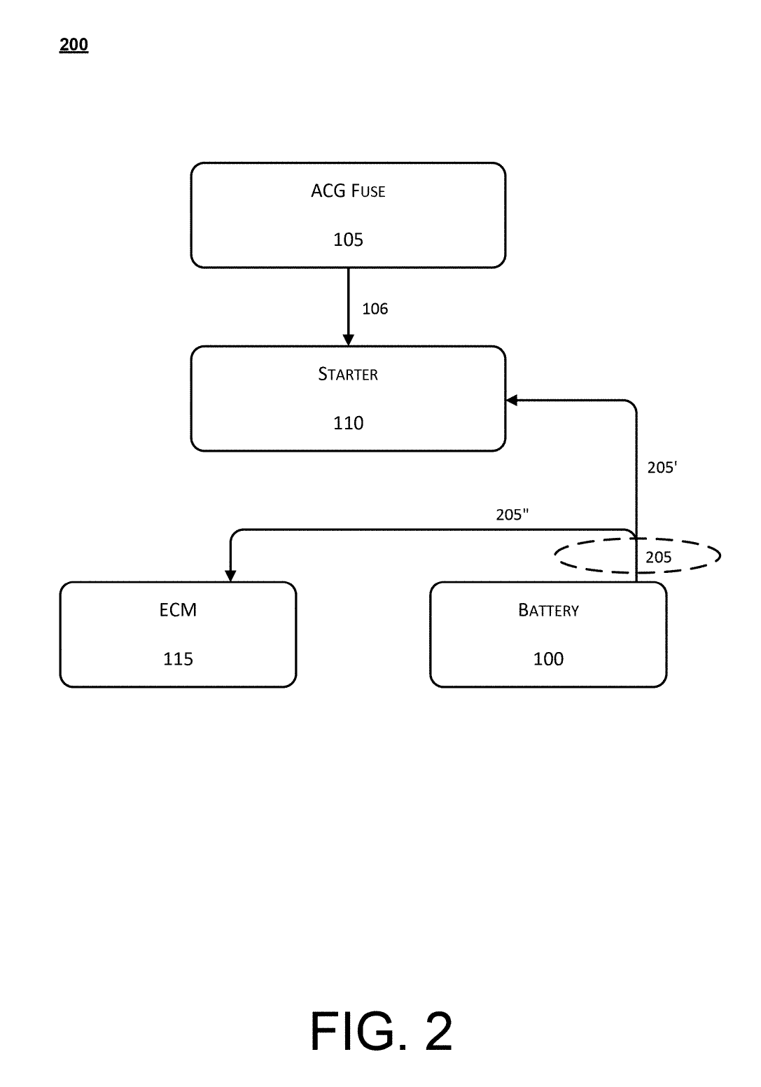

FIG. 2 shows an example implementation of an automotive power configuration 200 in accordance with at least some of the examples described herein.

As in the depiction of FIG. 1, power configuration 200 includes battery 100, ACG fuse 105, starter 110, and engine control module (ECM) 115.

Wire 205 is utilized to provide or direct power from battery 100 to starter 110 and ECM 115. More particularly, in accordance with the implementations described herein, wire 205 includes wire 205′ and 205″, crimped together by applying a shrink tube and/or sealant. When starting the automobile, wire 205′, stemming from crimped wire 205, provides or directs power from battery 100 to starter 110; and wire 205″, also stemming from crimped wire 205, provides or directs power from battery 100 to ECM 115.

In comparison to the known configuration of FIG. 1, power configuration 200 omits wire 108, used to provide or direct power to ECM 115, via wire 108, if wire 104 becomes unplugged or otherwise unserviceable. Instead, by crimping wires 205′ and 205″ to form wire 205, electric current may be provided or directed from ACG fuse 105 to ECM 115 even crimped wire 205 becomes disconnected from its corresponding terminal on battery 100 or is otherwise unserviceable, e.g., due to corrosion.

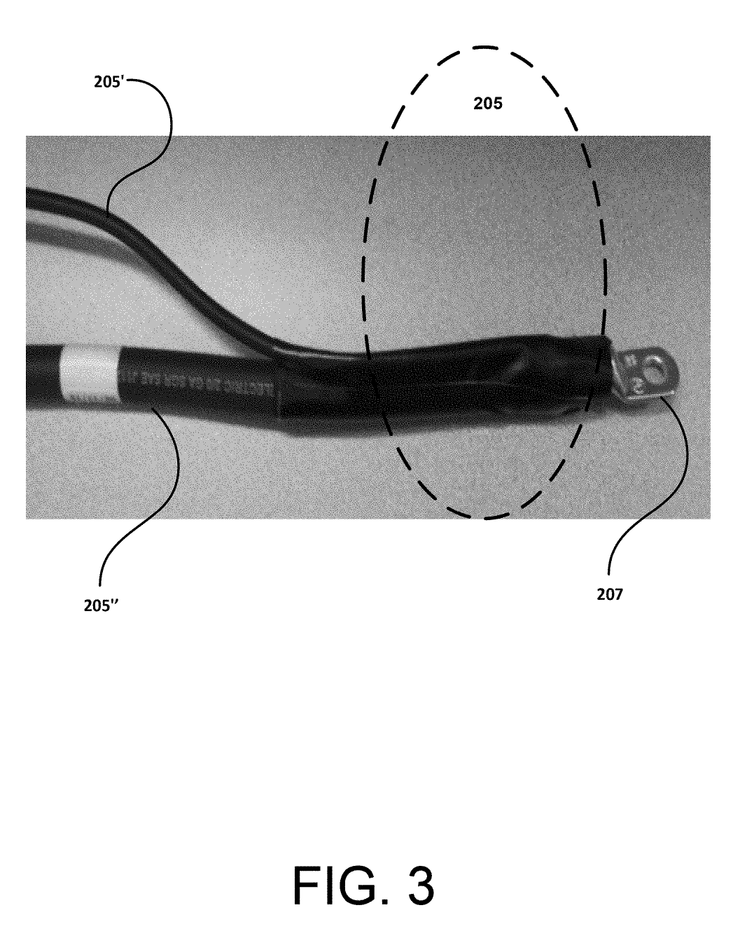

FIG. 3 shows an example implementation of crimped wire 205 for an automotive power configuration in accordance with at least some of the examples described herein, including that of FIG. 2.

In accordance with some implementations, wire 205′ is a positive battery cable 8983199760 and wire 205″ is a fusible link wire 8983451150; and crimped wire 205 is a combined cable 5-JX307864-0.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. Automotive power configuration, comprising:
a battery;
a starter;
an ACG fuse,
wherein the starter and the ACG fuse are electrically connected by a first wire; and
an electronic control module (ECM),
wherein the starter and the ECM are electrically connected to the battery by a second wire and a third wire, respectively, and
wherein further the second and third wire are crimped together to form a combined cable that connects to a terminal of the battery.

2. The automotive power configuration of claim 1, wherein:
the battery directs power to the ECM and starter, simultaneously, during engine start-up,
the ACG fuse directs power to the starter after engine start-up, and
the ACG fuse provides power to the ECM when the combined cable is disconnected from the battery terminal.

3. The automotive power configuration of claim 1, wherein the second wire and the third wire are crimped together by applying a shrink tube and sealant.

4. The automotive power configuration of claim 1,
wherein the second wire is a positive battery cable 8983199760 and the third wire is a fusible link wire 8983451150, and
wherein the second wire and the third wire are crimped together to form a combined cable 5-JX307864-0.

5. The automotive power configuration of claim 1, wherein the starter and ECM are not electrically connected.
